(19) United States
(12) Patent Application Publication
(10) Pub. No.: US 2008/0126115 A1
(43) Pub. Date: May 29, 2008

(54) System and method for handling a request for a good or service

(76) Inventors: S. Charles Bennett, Naples, FL (US); Kenneth M. Marwick, Bonita Springs, FL (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/978,025

(22) Filed: Oct. 25, 2007

Related U.S. Application Data
(60) Provisional application No. 60/855,294, filed on Oct. 25, 2006.

(51) Int. Cl. G06Q 30/00

(52) U.S. Cl. 705/1

(57) ABSTRACT

A system and method for handling a request for a good or service provided by a business, member, or professional. A determination of who may be able to fulfill the received request is made by comparing the request to information stored in a database regarding the goods or services associated with persons or businesses known to the service provider. One or more of those that may be able to fill the request are contacted.

### PRIORITY CLAIM

The present invention is related to, and claims the benefit of U.S. Provisional Application No. 60/855,294, filed on Oct. 25, 2006.

### FIELD OF INVENTION

Embodiments of the present invention relate to a system and method of providing a consumer the ability to request a good and/or service from one or more providers.

### BACKGROUND

There are scores of information gathering protocols that have been utilized through the years. These protocols however, have neglected to compile comprehensive and current information on the vast majority of businesses for the purpose of making the information easily accessible to the general public. Small businesses comprise 90% of all US companies. These small businesses drive the nation's economy, offering 75% of new jobs and generating 50% of America's private sector output. There are 22.9 million small businesses and the number continues to grow at a rapid pace.

In the 21st century, the Internet has become the primary source of information for consumers. However, the Internet can only provide information that is already stored and properly managed within the existing Internet domain. Algorithms and other mathematical equations, the nervous system that locates the data within the Internet, are of no use if the information desired has yet to be collected. Though, a significant number of businesses, including small businesses, are listed by categories, with a name, address and phone number, no comprehensive or current description of these businesses, their products, or services, or in the case of professionals, their biographical history, is as yet available.

Consumers need information and today, most of the information on businesses, products and services, are compiled on the larger businesses that market their products on a national or international scale. But consumers also require comprehensive and comparative information on the products and services available in their local markets. They want current information on what doctor, lawyer, or real estate agent to use; which store sells a specific product, or which stores are having sales and specials; where the best deals are on cars, insurance, dining; etc. Consumers spend the vast majority of their expendable dollars on small businesses, usually local businesses. It is estimated that consumers spend as much as 90% of their disposable income on local products and services and most of these products and services stem from small businesses. Consumers require information beyond a simple, name, address and location. They want current and more comprehensive information so they can make an informed decision before they spend money.

The typical methods of collecting new and accurate information, including information on a significant number of businesses and professionals are inherently ineffective. This is the primary reason that the information has yet to be compiled and properly managed. First, since the vast majority of businesses are small businesses, the owners or managers, generally lack either the time, knowledge, initiative or the financial capability to initiate and manage an online presence relating to their business. It is estimated that over 50% and as many as 95% of businesses, as yet, have any level of comprehensive information on their business, online. Secondly, the typical methods of collecting a mass of information, via surveys, whether telephone, face to face, or even online, are not effective for a number of reasons, (1) the cost to pay enough individuals to collect and compile such a massive amount of information has been prohibitive for most private enterprises and (2) the intrusiveness of one taking the survey limits both the ability to reach the necessary individual authorized to provide the information, as well as the inclination of the individual not to provide information to a stranger.

Therefore, the inefficiencies of a conventional survey are reasonably ineffective. Another reason that businesses or professionals are hesitant to provide information is because of their inability to easily edit, revise or correct the information, as necessary, therefore creating a major concern, on their part, that must be addressed.

Consumers also need a method to be furnished information on businesses, products and services in a manner that requires minimal effort on behalf of the consumer. Conversely, businesses and professionals constantly need new customers and clients. Many of the conventional methods to advertise or find new customers or clients have proven to be generally expensive and/or ineffective for most businesses, especially small businesses. In fact, most methodologies use the “shotgun” approach of soliciting new customers and/or clients. In this case they advertise to a large market of consumers, hoping that someone in that market is looking for the products or service that they provide.

### BRIEF DESCRIPTION OF THE DRAWINGS

The present invention is illustrated by way of example and not limitation in the figures of the accompanying drawings, in which like references indicate similar elements and in which:

FIG. 1 illustrates an embodiment of the overall system for providing member created business listings;

FIG. 2 illustrates an embodiment of a listing search page;

FIG. 3 illustrates another embodiment of a listing search page;

FIG. 4 illustrates an exemplary result of a listing search;

FIG. 5 illustrates an exemplary business listing;

FIG. 6 illustrates an exemplary professional listing;

FIG. 7 illustrates an embodiment of a method for registering a member with the service provider;

FIG. 8 illustrates an embodiment of a member dashboard;

FIG. 9 illustrates an embodiment of a method for referring (inviting) a friend to the service provider;

FIG. 10 illustrates an embodiment of a method for developing a listing by a member;

FIG. 11 illustrates an exemplary first “add listing” page that is accessible from a dashboard;

FIG. 12 illustrates an exemplary page on which the member selects an existing business listing or if the business does not have a listing;

FIG. 13 illustrates an exemplary second “add listing” page;

FIG. 14 illustrates an embodiment of a method for a business to sign-up with the service provider;

FIG. 15 illustrates an embodiment of a method for a editing an existing listing;

FIG. 16 illustrates an exemplary member family shown as three tiers (levels);

FIG. 17 illustrates an embodiment of a method for determining compensation based on a business subscribing to the service provider;

FIG. 18 illustrates an embodiment of a method for a service provider to supply to a member updated local listing Web site;

FIG. 19 illustrates an exemplary data structure describing a request;

FIG. 20 illustrates an exemplary “anonymous” transaction involving a member of the service provider;

FIGS. 22(a) and (b) illustrate an embodiment of a method for enabling the fulfillment of a goods and/or services request; and

FIG. 23 shows an embodiment of a computing system.

### DETAILED DESCRIPTION

As described earlier, local businesses are typically not satisfied with their Internet business presence. This may be because of a lack of resources, expertise, time, etc. Below we describe a new approach to providing large and small, local or multiple location businesses with an easily obtainable presence on the Internet through a local listing service provider (“service provider”). The service provider compiles business information with the help of its members and creates an Internet presence for these businesses.

Business information is collected not only from the businesses themselves but by individual consumers (members of the service provider) under an approach designed to financially benefit everyone involved (members (business and consumer), businesses, and consumers). This information is conveyed to a user as a listing, which is a short description of the local business including its products, services, location, etc. If the listing describes a professional, e.g., a lawyer, other relevant information such as a bibliographic history may be provided, which may include education, areas of expertise, years in practice, licenses, etc. Other listing types may also be utilized including “help wanted” listings, personal ads, etc. These listings are again created and maintained by members of the service provider. Through this approach, the service provider will develop a comprehensive collection of current information on businesses and professionals, including their products, services, and sales and/or specials. These listings are searchable via a search engine either supplied by the service provider or a third party search engine such as Google™ or Yahoo!™. In addition to a listing, in one embodiment the service provider supplies a link to a page that allows a business to include more information and photograph(s).

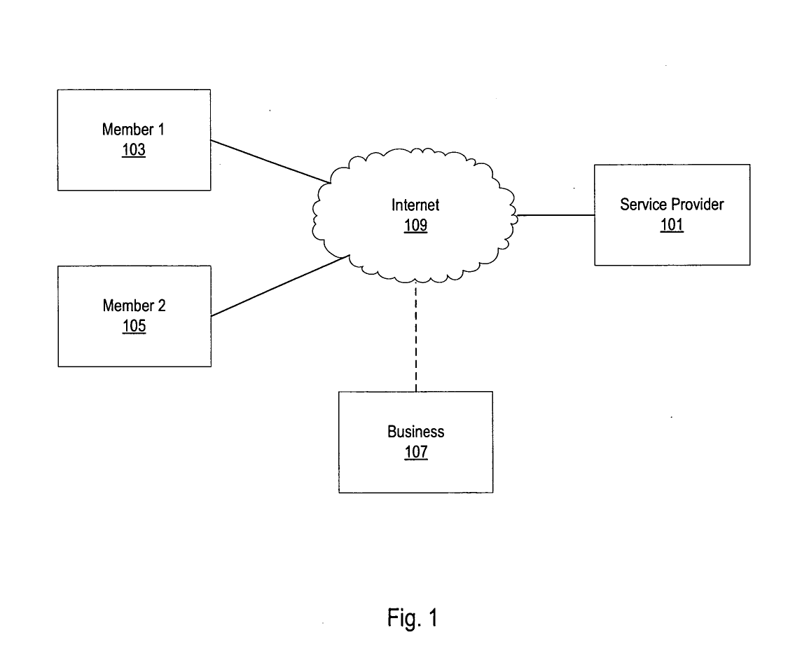

FIG. 1 illustrates an embodiment of the overall system for providing member created business listings. The service provider 101 receives listings from business such as business 107 through the Internet 109. These listings are developed by members of the service provider such as Member 1103 and Member 2105. The members use various tools provided by the service provider 101 to develop listings for businesses and/or professionals for the service provider 101 to host online. Businesses, such as business 107 may also be members of the service provider 101 and may create and/or maintain their own listing. However, as illustrated by the dotted line, these businesses may not have an Internet presence and must rely on members to create their listing for them.

### Exemplary Embodiments of Functionality Provided by a Service Provider

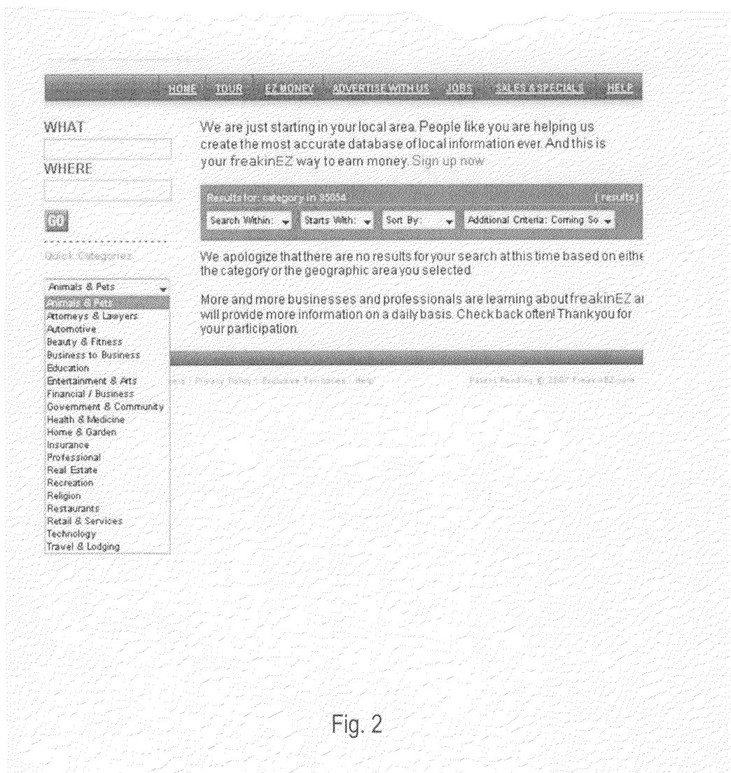

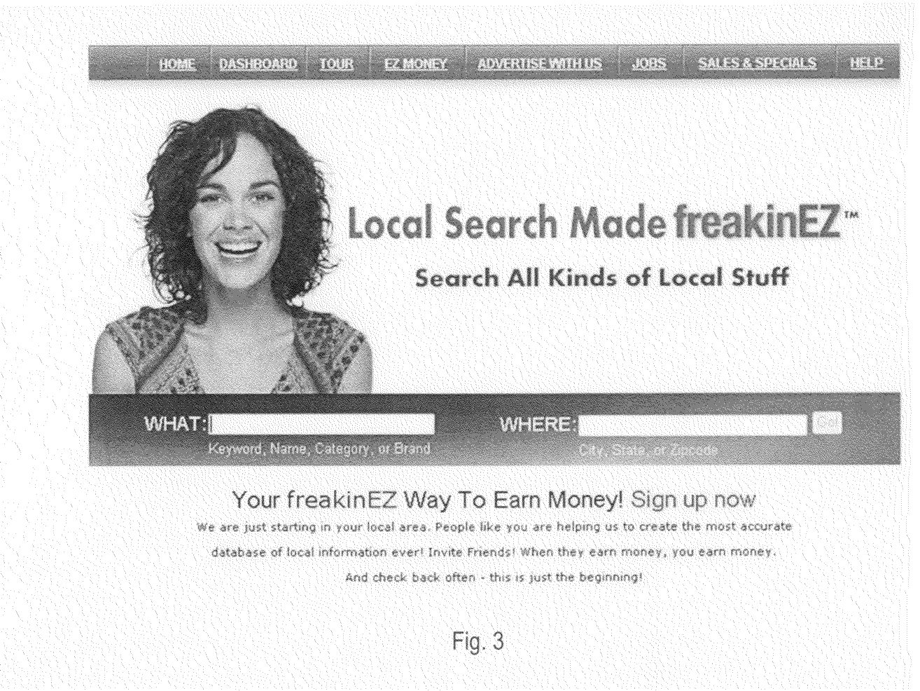

FIG. 2 illustrates an embodiment of a listing search page. Users of the search page may search the listings supplied by the service provider for the local business or service that they need. Searches may be categorical, location specific, and/or specific in nature. Exemplary categories include: animals and pets; attorneys; automotive; beauty; fitness; education; entertainment and arts; financial/business; government and community; health and medicine; home and garden; insurance; professional; real estate; recreation; religion; restaurants; retail and services; technology; and travel and lodging. Subcategories of the categories may also be used. Location specific searches may be performed by address, city/state, and/or zip code. Or, a user may simply search by business name, keyword, or brand name. FIG. 3 illustrates another embodiment of a listing search page.

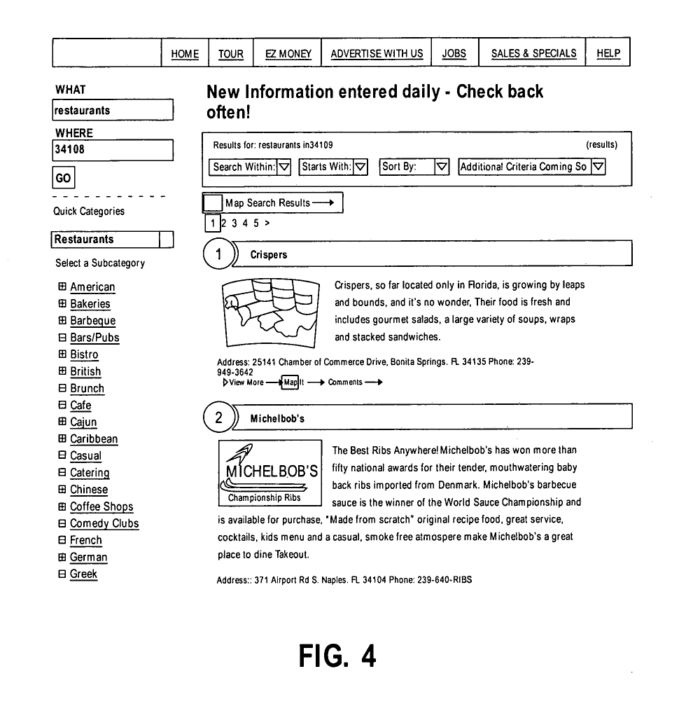

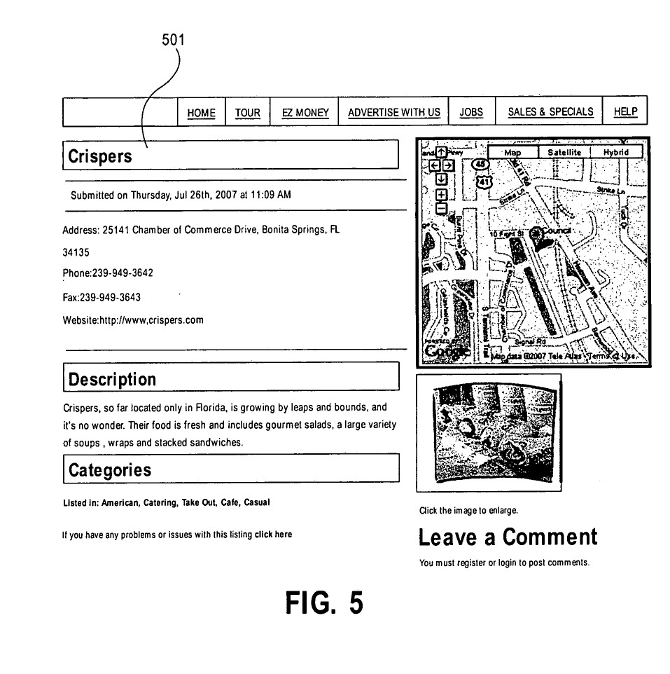

FIG. 4 illustrates an exemplary result of a listing search. These search results represent results for a search of restaurants in the 34708 zip code. Any person accessing the service provider's site may perform this search (including members and non-members). As illustrated, the search returned several listings. A user may select a listing for more information (see FIG. 5). Additionally, the search result may be further tailored by subcategory, name, keyword, brand name, mileage from location, etc. Finally, the search result may also provide a map of all of the locations of the businesses returned by the search.

FIG. 5 illustrates an exemplary business listing. This listing 501 is for Crispers (a restaurant in Bonita Springs, Fla.). As illustrated, the listing includes the contact information for Crispers including its address, phone and fax numbers, and website address. A short description of Crispers is included in the listing. As illustrated, this particular business is listed in several categories. The service provider typically includes a section for registered members to leave comments about the business. A listing may also include a map of the location of the business and a link that provides directions to the business. Any part of this listing may be edited by the business if it is a member of the service provider.

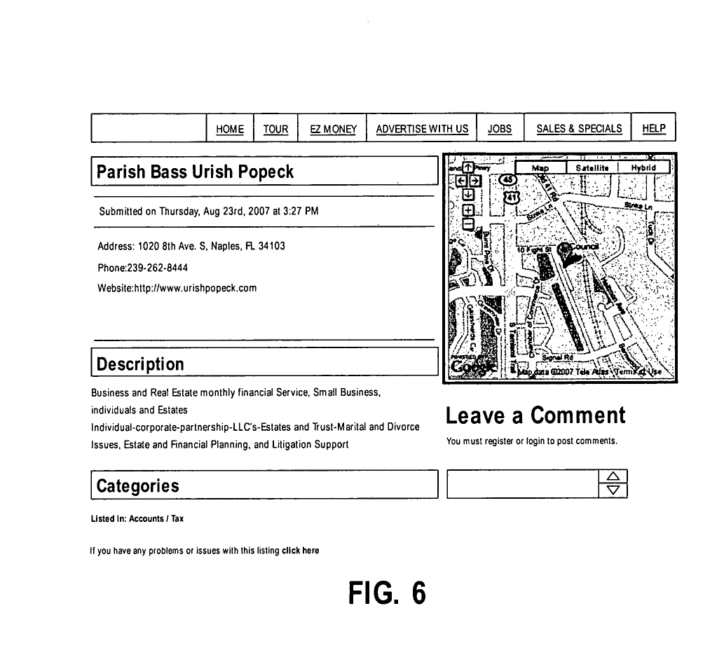

FIG. 6 illustrates an exemplary professional listing. As illustrated, the listing includes the contact information for the firm including its address, phone and fax numbers, and website address for an accounting firm. A short description of the firm is included in the listing. This particular business is listed in the “accounting” category and then “tax” subcategory. The service provider typically includes a section for registered members to leave comments about the business. A listing may also include a map of the professional's location and a link that provides directions to the business. Any part of this listing may be edited by the professional if it is a member of the service provider.

### Becoming a Member of the Service Provider

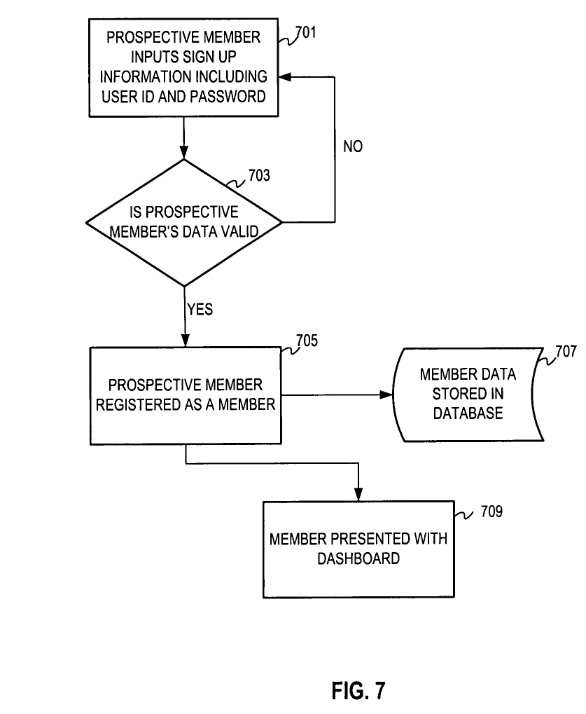

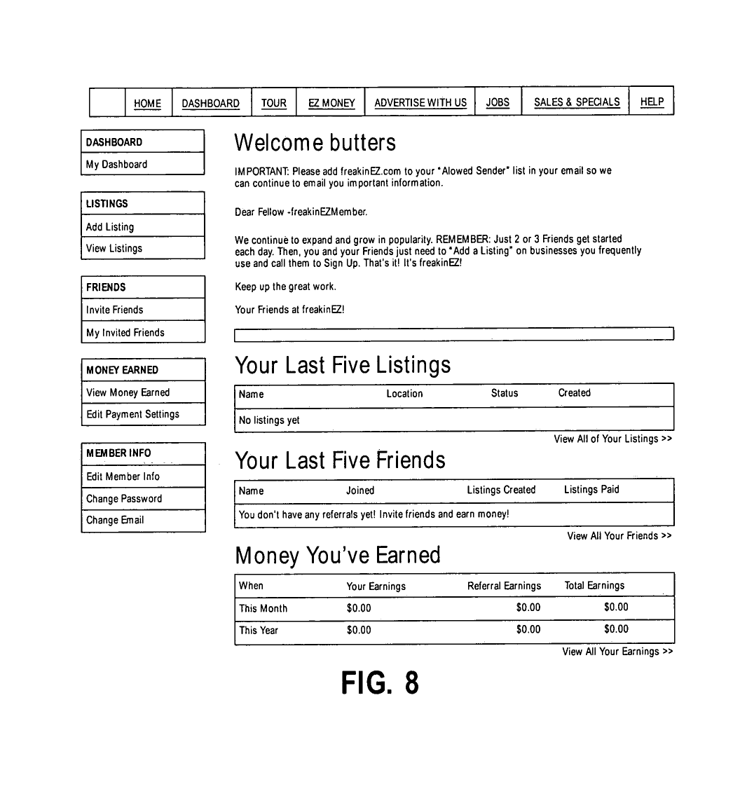

FIG. 7 illustrates an embodiment of a method for registering a member with the service provider. The prospective member inputs “member details” at 701. These member details include a member identification (“ID”) and a password. Member details typically also include one or more of the following: the member's name, email address, zip code, birth date, and an indication of the person that referred the prospective member (if applicable). Additionally, a member's details should include information as to how the member desires to be paid. Details will include the physical address of the member and a social security number or tax ID. Forms of payment include, but are not limited to, payment to a PayPal™ or Google™ Checkout account, payment to a bank account, payment to a debit card, a check or money order sent to a physical location, etc. However, this payment information may be inputted at a later time.

The prospective member's member details are validated at 703. Validation includes determining if the member name is available, the password is acceptable, etc. If the details are not valid, the prospective user will be prompted to change his/her details.

Once the prospective member's details have been validated the prospective member becomes a registered member at 705. The member's details are persisted to a database at 707. The member is then presented with his member dashboard at 709.

### Exemplary Member Dashboard

FIG. 6 illustrates an embodiment of a member dashboard. As illustrated, the member dashboard 801 is a webpage that includes links to various member functions including one or more of the following functions: adding a listing, viewing existing listings, inviting a friend to join the service provider, viewing activities of friends, calculating potential earnings for the member, viewing the amount of money earned by the member, editing member information (e.g., user name, password, email address, and financial information), etc. The dashboard 801 may also include links to other portions of the service provider's website such as a tour of the site, an advertising section, an employment section, a sales and specials section, a help section, etc. This particular member has not created a listing and has not referred any friends.

While the dashboard 801 is illustrated as a website it should be understood that the dashboard 801 may take on other forms such as a standalone client. Additionally, the functionality provided by the dashboard 801 may be spread across one or more pages.

### Referring a Friend to the Service Provider

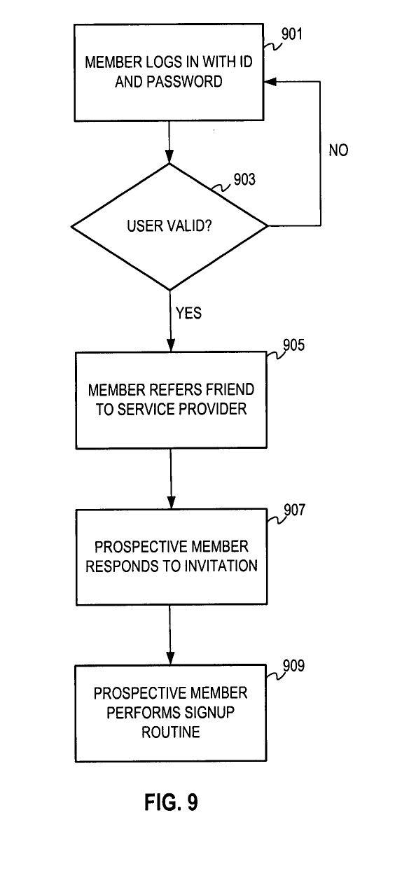

FIG. 9 illustrates an embodiment of a method for referring (inviting) a friend to the service provider. As detailed above, there are many benefits to referring friends or acquaintances to join the service through a member. These referral members not only help the number of listings grow, but also potentially provide additional revenue to the person that referred them to the service provider.

An existing member attempts to log into his account using his/her username and password at 901. A determination of the validity of the provided credentials is made at 903. If the username and password are not valid, then the member will be prompted to resubmit his/her username and password. If the credentials are valid, then the member is typically taken to his/her personalized dashboard such as the dashboard illustrated in FIG. 6.

From the dashboard (or standalone equivalent), the member takes the necessary steps to refer a friend or acquaintance to the service at 905. In one embodiment, the routine involves crafting and sending an email or other electronic message to the prospective member. The message includes a reference to the referring member, e.g., through a link. Of course, a member may also simply tell a friend or acquaintance about the service provider and have that friend or acquaintance give credit to the member upon registering.

At some later point in time, the prospective member responds to the invitation at 907 and performs a signup routine (such as the one described in reference to FIG. 1) to join the service at 909.

### Developing a Listing

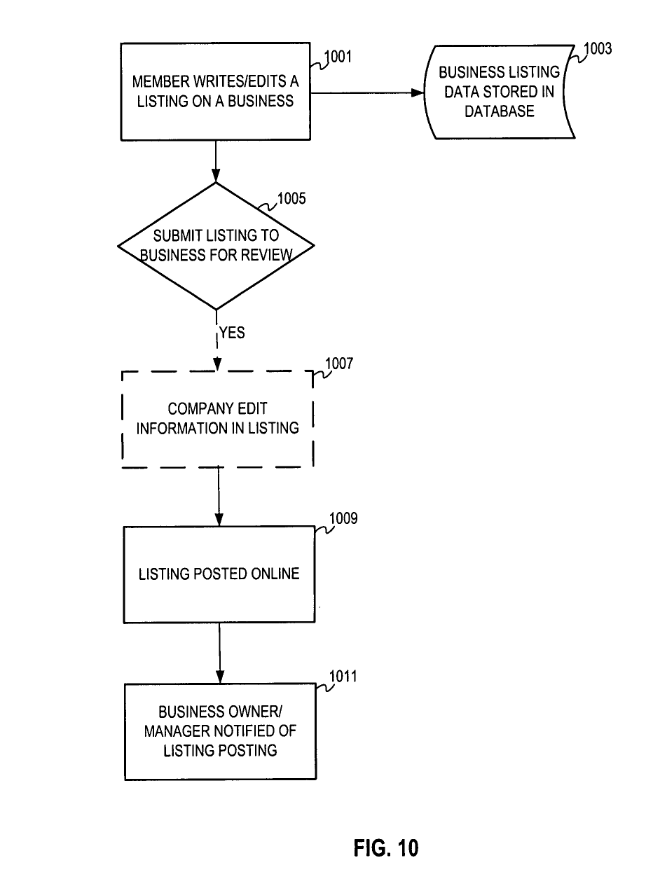

FIG. 10 illustrates an embodiment of a method for developing a listing by a member. As described earlier, a listing may be generated by a member and proposed to a business for inclusion by the service provider. Of course, a business is free to develop its own hosted listing. At 1001, a member writes or edits a listing describing a business. There are numerous ways for a member to obtain information about a business, i.e., a member may write about a business he/she is employed with or frequents. Information on businesses from printed ads in local newspapers, local magazines, phone directories, and other specialized publications may also provide information for a listing. Significant information may also be found on individual websites, other search engines, or websites that focus on specific industries and/or business categories, i.e., restaurants, shopping, hotels, etc.

When generating a listing for a professional, there are also several different sources of information. A member may choose to write about professionals that he/she knows. A member may contact a professional and ask for their information. Printed ads in local newspapers, local magazines, phone directories, and other specialized publications also may provide information for a listing. Some professionals also maintain individual websites containing this information. Additionally, other search engines or websites that focus on specific categories, i.e., doctors, dentists, hospitals, insurance companies, realtors, legal associations, etc. may supply information needed to create a listing for a professional.

In addition to the description, a member should try to provide the following contact information: address of the business, telephone and fax numbers of the business, e-mail address of the business, or the name and title of a contact person at the business. A contact person is usually the owner, manager or advertising manager who has the authority to make business decisions and/or advertising decisions on behalf of the business.

A member-created listing is persisted to a database of the service provider at 1003. The service provider may utilize several different databases for redundancy and/or efficiency purposes

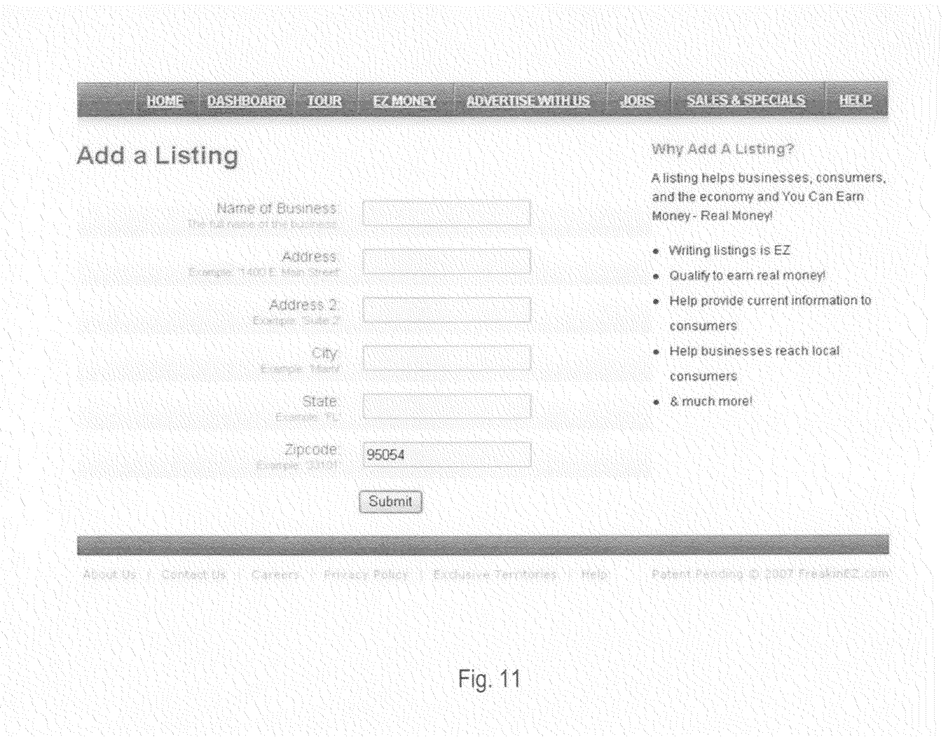

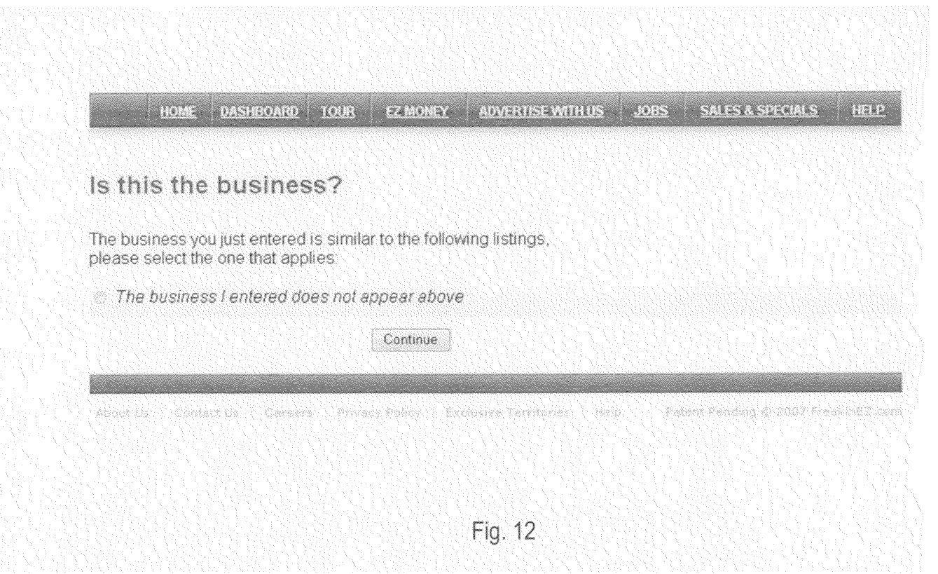

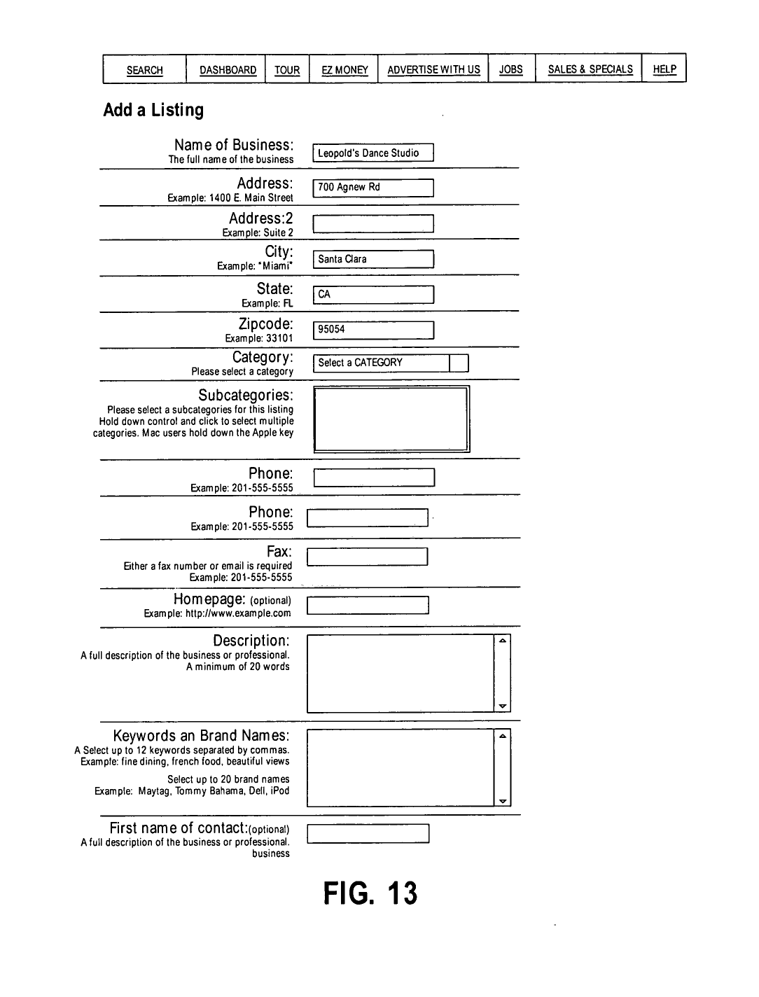

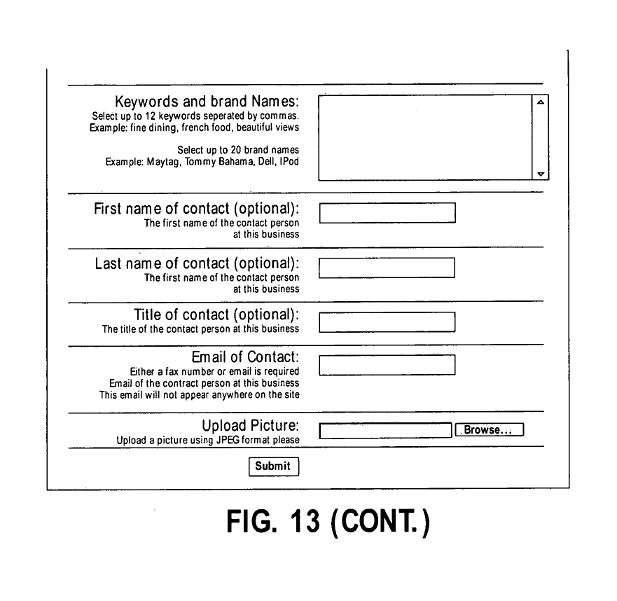

FIG. 11 illustrates an exemplary first “add listing” page that is accessible from a dashboard. As illustrated, a member first supplies the name and address of a business. FIG. 12 illustrates an exemplary “Is This The Business?” page on which the member selects an existing business listing or if the business does not have a listing the member continues to a second “add listing page.” FIG. 13 illustrates an exemplary second “add listing” page. In this page the member supplies additional information (and the name and address if not provided earlier) including, but not limited to, the category or categories of the business (including sub-categories), a phone and fax numbers (if available), a URL to the business' homepage (if available), a description of the business, some keywords associated with the business to be used for searching, brand names, contact name (if available), and/or a picture (if available). Of course, a single “add listing” page or client may be used or the “add listing” function may be further divided into more pages. Similar pages are available for developing job openings or professional listings.

At some point later in time the member or the service provider will present the listing to the business for review at 1005. This presentation may be made in person, via fax, via a link to the listing as is (online for the business to view), etc. The business may be free to decline the listing if it is not satisfactory. The business may also edit (or have the member edit) the information contained in the member created listing at 1007. Of course, the listing is editable both prior to and after inclusion with the other listings.

After approval of the listing by the service provider and/or business and payment to the service provider, a listing is included with the other listings at 1009. At this point, the business now has a searchable presence that is freely accessible. The business is notified of this inclusion at 1011. In another embodiment, the listing is hosted by the service provider regardless of input from the local business.

### Method for a Business to Join a Service Provider

Typically, prior to the listing going online, the business should also become a member. However, the listing may be put online prior to the business becoming a member so that the business can review the listing online. If the business does not want to become a member it cannot revise its listing (other than to change original information included in the listing). However, it may request that the listing be removed. Additionally, according to an embodiment, businesses that are paying members (they are paying to maintain their listing with the service provider) will have their listing ahead of non-paid listings when a search has been conducted.

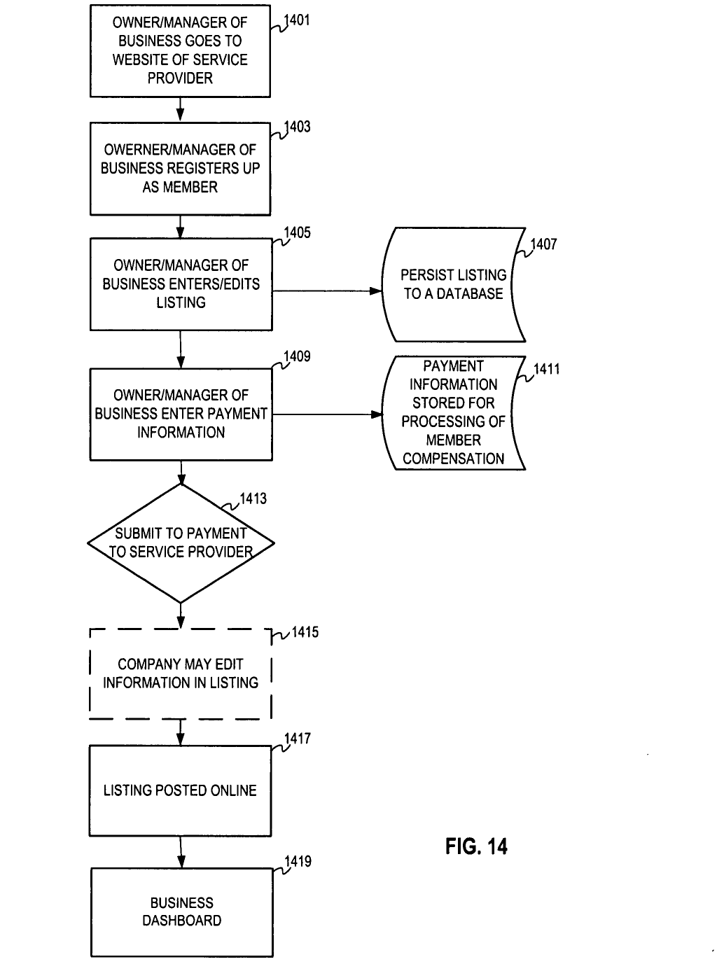

FIG. 14 illustrates an embodiment of a method for a business to sign-up with the service provider. A business visits the service provider to determine if it should join at 1441. For example, the business' owner or manager visits the website of the service provider much like a prospective member does. Once at the website, the business can see what other businesses are listed, what services the service provider offers to businesses and consumers, etc.

If the business is interested in becoming member and/or placing a listing, the business signs up as a member at 1403. The sign up procedure for businesses is similar, if not identical, to the procedure for an individual to sign-up with the service provider. During sign-up it is important for the business to give credit to the member that provided the referral and/or listing to the business. If the business does not provide credit, it is difficult to ascertain if the member should get paid. However, the business may provide this information at a later time or the member's profile could be checked for created listings to see if the member created one similar to the one accepted by the business.

If a listing already exists, the business may edit the listing or have the listing edited on its behalf at 1405. Alternatively, if there is not a pre-existing listing for the business, the business may create one at 1405. The business' listing is persisted to a database at 1407.

If it has not already done so, the business may supply its payment information, e.g., credit card, PayPal™, Google™ checkout, bank account information, etc. to the service provider at 1409. This payment information is stored for processing of member compensation at 1411 and payment is submitted to the service provider at 1413.

At any point in time the business may edit its listing including after submission of payment to the service provider at 1415. After payment has been received, the listing is posted online at 1417 and is searchable through the service provider's interface or other search engine (indexing search engines such as Google™ are likely to index the service provider's website as well thereby making the listings available using their index(es)). Finally, in an embodiment, after the listing is posted the business is routed back to its dashboard at 1419.

### Editing a Listing

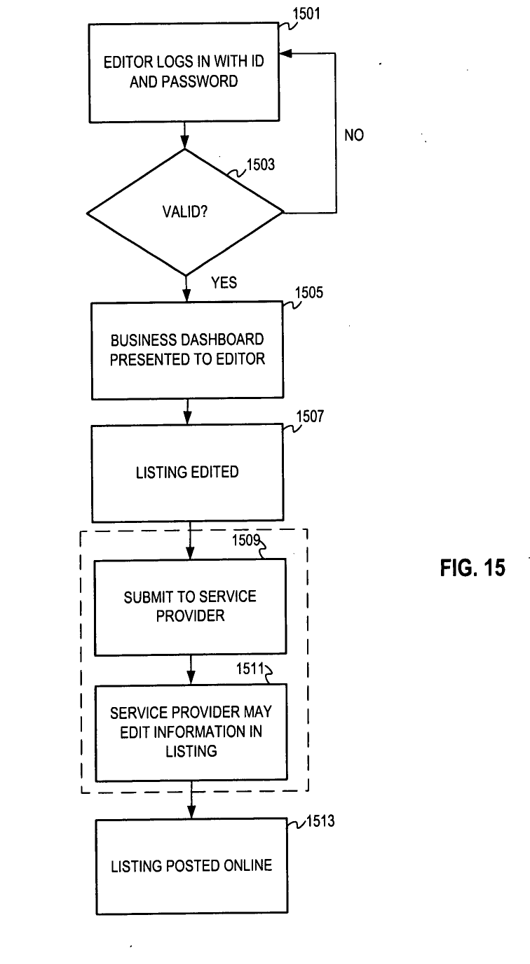

One of the unique aspects allowed with the above-described listing approach is that a listing may change over time. The listing may be supplemented with specials, updated goods or services provided by the business, updated contact information, etc. with relative ease. Additionally, persons with little to no computer experience are able to edit and post listings. FIG. 15 illustrates an embodiment of a method for a editing an existing listing.

In order to edit a listing, the editor of the listing needs to log in to the service provider at 1501. At 1503, a validation of the log in credentials is performed. Once logged in, the editor is presented with their dashboard at 1505. If the editor is a business, then this dashboard allows the business to edit its listing(s). A business may also create listings for others in which case the dashboard will also present those listings if available. In an embodiment, once a listing is accepted by a business, it can only be edited by the business unless the business has indicated otherwise. If the editor is a normal member, his/her personal dashboard allows him/her to edit listings that they have created. This may be necessary to update a listing that was rejected by a business. In an embodiment, business members may also run employment ads with the service provider in an employment section. Anytime the business wants to offer services or goods beyond the regular scope of their business (such as a sale or special) it may do so through its dashboard. In an embodiment, consumers may view all sales and specials by clicking on a link provided by the service provider.

The listing is edited at 1507. Almost any aspect of the listing may be edited including, but not limited to, the name, contact information, description, etc. of the business. In an embodiment, the business may also edit comments posted about it in the listing, however, this is atypical.

The edited listing is submitted to the service provider at 1509. In an embodiment, the listing may undergo a review process at 1511. The review process allows the service provider to ensure that the content of the listing is in compliance with whatever guidelines it has in place. Accordingly, there may be some delay between when changes are made and when they are reflected on the website. An acceptable listing is then republished online at 1513.

### Tiered Member Levels

A member's compensation depends on several factors including: the businesses that he/she brings in (and sign up and pay for the service provider for the ability to maintain a listing) and the businesses that his/her “friends/referrals” bring in that also sign up and pay the service provider.

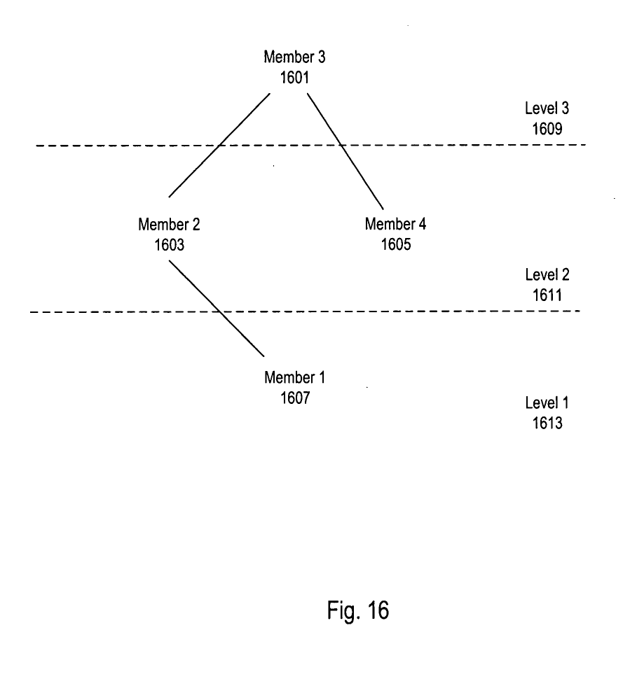

FIG. 16 illustrates an exemplary member family shown as three tiers (levels). This configuration graphically depicts the relationship between members of the service provider. “Member 3” 1601 is designated as being in the lowest level or Level 3 1609 with respect to the member (“Member 1,” 1607) that brought in a business. Being in this level means that “Member 3” signed up with the service provider without being prompted (or at least did not give credit to the person that prompted him) by another member. “Member 3” 1601 referred two members to the service provider, “Member 2” 1603 and “Member 4” 1605. The latter two members are in different level (Level 2 1611) than “Member 3” 1601. These two members are closer to the member that brought in the business to the service provider. Of these two, only “Member 2” 1603 is related to “Member 1” 1607 (the member that brought in the business. “Member 1” 1607 is in the top level or Level 1 1609.

As illustrated, “Member 3” 1601 has the potential to financially benefit the most if each member signs up the same amount of businesses as “Member 3.” This will allow for “Member 3” to receive a percentage of the fees brought in by “Member 2” 1603, “Member 4” 1611, and “Member 1” 1607. Since “Member 1” 1607 has not brought in any other members, he only gets a portion of the fees that he directly brings into the service provider.

To promote growth of the service provider, each business is charged the same fee. However, in one embodiment, the fee charged to a business is dependent on the local market as determined by the service provider. For example, businesses in New York City would pay more than businesses in Des Moines, Iowa. In this market specific scenario, members from higher paying markets could end up making more for the same amount of work.

### Member Compensation

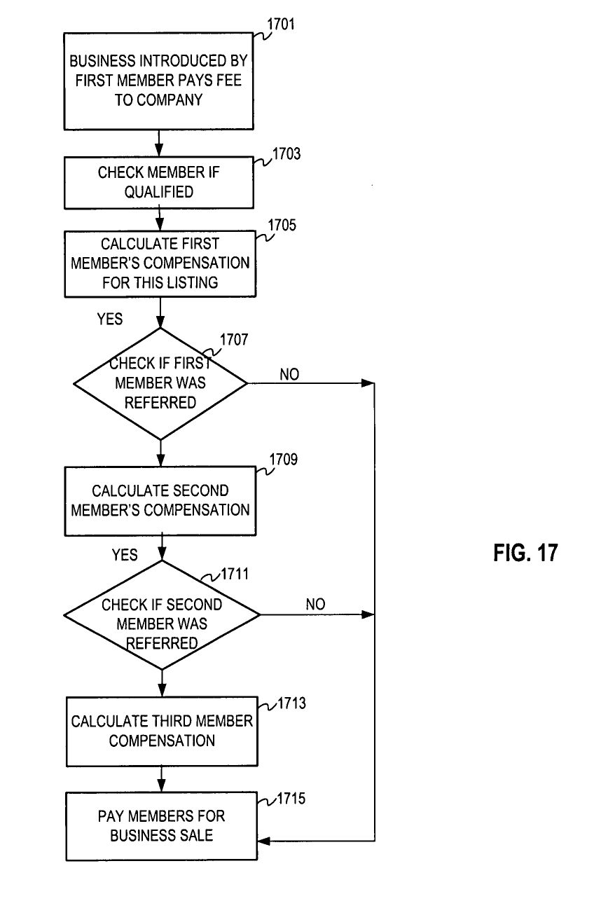

FIG. 17 illustrates an embodiment of a method for determining compensation based on a business subscribing to the service provider. A business introduced by a first member pays a fee to the service provider at 1701. The business has accepted the business listing developed by the first member and has agreed to have the service provider host the listing. For example, “Member 1” introduced “Butters' BBQ” to the service provider and developed a listing for “Butters' BBQ.” When “Butters' BBQ” accepted that listing, it paid a fee to the service provider.

A check to determine if the first member is qualified is performed at 1703. According to an embodiment, a member must have a minimum of two “active clients” in a pay period to qualify for payment from the service provider. An “active client” is a business (or professional), on which the member wrote a listing, and that joined service provider as an active client. According to another embodiment, non minimum active clients are required for the member to get paid.

The compensation to be paid to the first member is calculated at 1705. The compensation is a portion (percentage) of the fee paid by the introduced business to the service provider. Any percentage may be used for this calculation. Of course, adjustments to the compensation amount may be utilized. For example, if a member has brought in a large amount of businesses, the member would get a larger percentage of the associated fees. Or, a member may get a bonus for reaching certain milestones such as certain number of businesses signed up in a month, year, etc.

A check to determine if the first member was referred to the service provider by another member is performed at 1707. If the first member was not referred, then the first member is the only member that gets paid for the business signing up with the service provider at 1715.

If the first member was referred to the service provider by a second (another) member, then that second member will also get a portion of the business' fee paid to the service provider. At 1709, the portion due to the second member is calculated. For example, if “Member 1” was referred to the service provider by “Member 2” and “Member 1” convinced “Butters' BBQ” to have a listing hosted by the service provider, “Member 2” also gets a portion (percentage) of the fee paid by “Butters' BBQ” to the service provider.

There are numerous ways to divide the fee paid by a business between members. In one embodiment, the fee to be paid to a group of members is a set percentage that is apportioned (equally or unequally) between the members responsible for the business paying the fee. For example, the members may get a total of 25% of the fee paid by a business. This 25% may be apportioned in any number of ways. Typically, the member that directly introduced the business to the service provider gets the largest percentage of this allotment on a sliding scale, Of course, using this type of configuration may result in members not giving credit to those that introduced them to the service provider as their portion would be lessened.

In another embodiment, there is not a set total percentage apportionable to members that brought in a business (directly or indirectly), however, there are set values depending upon the level that the member is associated with. For example, “Member 1” 1607 of FIG. 16 is in the first level. This means that he brought in the business. Accordingly, “Member 1” 1607 typically would get the largest percentage of the fee paid by business that he brings in. Related members (“Member 2” 1603 and “Member 3” 1601) would get a lesser percentage than “Member 1” 1607. Additionally, in an embodiment, the percentage due to a member decreases as the level value increase. For example, Level 1 1609 receives more than Level 2 1611, and Level 2 1611 receives more than Level 3 1613. The payment to the members generally does not exceed the total paid by the business to the service provider. However, depending upon other revenue sources for the service provider such as banner ads, etc. or special circumstances (attempted growth of the service provider's business) the payment to members may exceed the total paid by the business to the service provider.

At 1711, a check is performed to determine if the second member was referred to the service provider. If the second member was not referred, then only the first and second member will get a portion of the business' payment at 1715.

If the second member was referred to the service provider by a third member, that third member will also get a portion of the business' fee paid to the service provider as calculated at 1713. As discussed above, there are numerous ways to determine how much the third member should be compensated. Additionally, any number levels of member referral may be used. In an embodiment, the number of levels of member referral is up to four levels beneath a member.

According to one embodiment, a member receives 50% of the initial amount paid by any business on which he/she wrote a listing. The member will continue to earn 90% of any amount paid by that business on a monthly basis. Friends from the second level (referred by the member) earn 90% for the member on the initial amount paid by the business, when paid, and 5% monthly thereafter. Friends from the third level (referred to the service provider by one of the member's friends) earn 90% for the member on the initial amount, when paid, and 5% monthly thereafter. Friends from the next level earn the member 5% on the initial amount when paid and 2.5% monthly thereafter. Friends of the next level after that earn the member 5% on the initial sale when paid and 2.5% monthly thereafter, etc. Of course, any other payment scheme may be utilized. When a member earns a commission, he/she will be notified by the service provider. At that time, if the member had not previously done so, he/she should provide the service provider with additional information including banking information so that the service provider can facilitate a payment (such as a direct deposit) to the member.

### Service Provider Overview Method

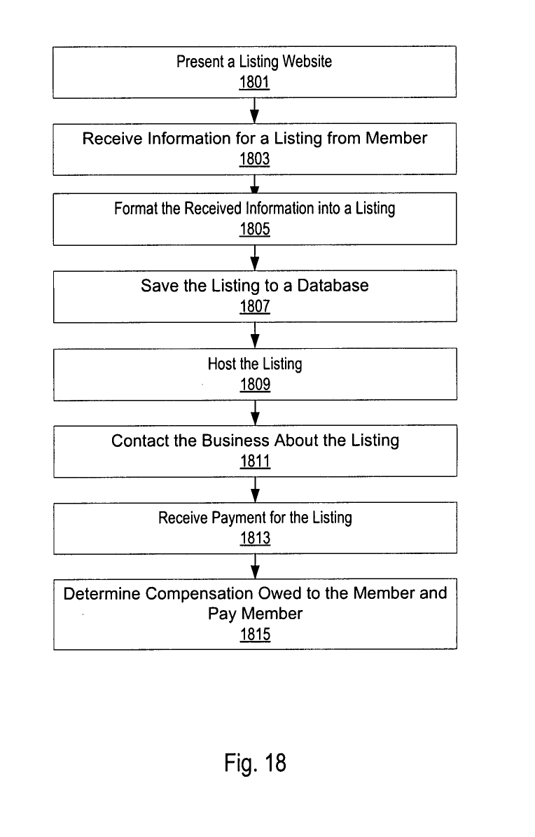

FIG. 18 illustrates an embodiment of a method for a service provider to supply to a member updated local listing Web site. The service provider presents a Web site at 1801. This Web site contains the pages described earlier including pages for: searching listings, listings themselves, member dashboards, etc.

At 1803, the service provider receives information about a listing from a member. The type of information received has been previously described. Additionally, this information is typically received via a page or pages that the service provider supplied to the member such as the pages illustrated in FIGS. 11, 12, and 13.

The service provider formats this information into a listing at 1805. Exemplary listings have been previously discussed. The listing is saved to a database at 1807.

Finished listings are hosted by the service provider at 1809 and made available to a user visiting the Web site of the service provider.

The service provider contacts the business about the listing at 1811. As described earlier, this allows the business to review the listing and possibly decide to join the service provider. If the business does join the service provider and pays to maintain the listing, then the service provider receives this payment at 1813.

Once payment has been received, the service provider determines the compensation owed to the member under the terms set forth by the service provider for compensation for listing creation and pays the member at 1815.

### Exclusive Territories

In an embodiment, the service provider utilizes “regional directors” in specific areas. These areas are designated around cities, towns and metropolitan areas, and generally based upon television and radio markets. Regional directors are individuals or businesses that contract (license) with the service provider to allow them to earn “overrides” on all sales generated in their territory. The cost of becoming such a regional director depends on the market of each exclusive territory.

In an embodiment, the service provider utilizes “regional directors” in specific areas. These areas are designated around cities, towns and metropolitan areas, and generally based upon television and radio markets. Regional directors are individuals or businesses that contract (license) with the service provider to allow them to earn “overrides” on all sales generated in their territory. The cost of becoming such a regional director depends on the market of each exclusive territory.

### Specific Member Requests

A more effective approach to providing knowledge about a good and/or service sold by a seller to a consumer is to provide information directly to consumers who have requested specific information. This affords the business a much higher likelihood of creating a sale.

Allowing consumers to request information, possibly in a confidential manner, and distributing the request directly to businesses capable of fulfilling the request, benefits both the individual consumer as he/she will not have to conduct a search themselves and the business because of the opportunity to sell directly to a consumer who has already indicated an interest in that particular good or service.

Leveraging the data acquired by the service provider allows consumers to easily collect and compare information on products and services based on the efforts of others who have provided the service provider with information on businesses and professionals.

The service provider provides a function for a goods and/or services request. Anyone with access to a computer and the Internet may initiate contact with any business, professional, or member of the service provider that may offer the specific products or service requested by the initiator authoring the request.

The specific goods and/or services provided by businesses and professionals who have listings with the service provider or members of the service provider are maintained within one or more databases. A consumer first initiates a request to the service provider for a particular good and/or service. The request is directed by the service provider to a specific target who could potentially fulfill the request according to information that the service provider has. The request may also be viewed by the service provider for approval prior to sending it to the target. The businesses, professionals, or other members contacted by the service provider then send their responses to the author of the request either through the service provider or directly. The consumer then has the option of comparing the information provided by all respondents and determining if they want to request additional information or initiate some other action.

In an embodiment, requests for information from a member of the service provider about the availability of specific goods and/or services are substantially anonymous from the standpoint of the receiving businesses, professionals, or consumer members. For an anonymous request, the receiver is provided with an identifier for the requester by the service provider (or third party). This identifier is intended to hide the identity of the requester from the receiver so that the receiver cannot directly contact the receiver at a later date with spam or other unwanted messages.

There are several different ways to provide requester anonymity. In an embodiment, the service provider maintains a data structure that stores the relationship between the requesting member's ID and an “anonymous” ID provided by the service provider. This “anonymous” ID may be temporarily associated with the requesting member (for example, the “anonymous” ID is only used for a single transaction or used for a short period of time) or permanently assigned to the requesting member. “Anonymous” IDs may be any alphanumeric string and may be generated randomly, assigned by membership signup number, etc. Preferably, a receiver should not be able reverse engineer an “anonymous” ID to determine who the actual requesting member is. Any anonymization technique may be utilized.

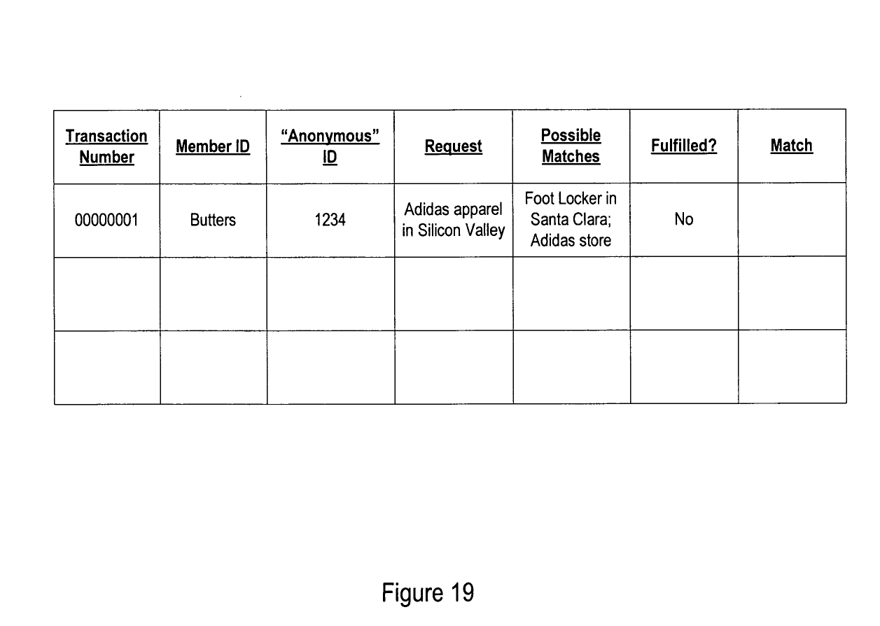

An exemplary data structure describing a request is shown in FIG. 19. This data structure (table, list, linked list, etc.) includes one or more of the following fields: transaction number (this is the number of the request); requesting member ID; an “anonymous” ID (if used); a copy of the request made; a listing of possible matches; an indication of whether or not the request was fulfilled; and the business, professional, or member that fulfilled the request. Other fields may also be utilized such as fields for rating the business, professional, or member or the transaction, a field for the time limit for the request, date of request, etc. In an embodiment, businesses, professionals, and other members with higher ratings are given preference over those with lower or no ratings. In another embodiment, businesses and professionals pay a fee to the service provider to increase their chance of referral.

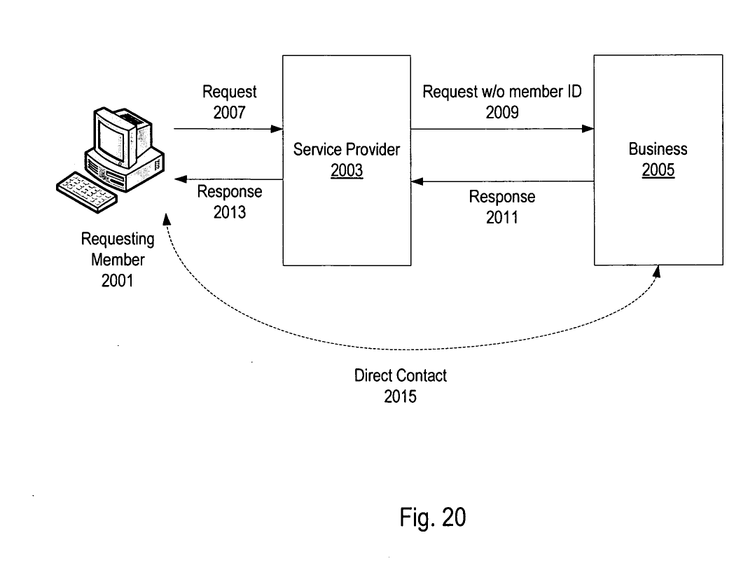

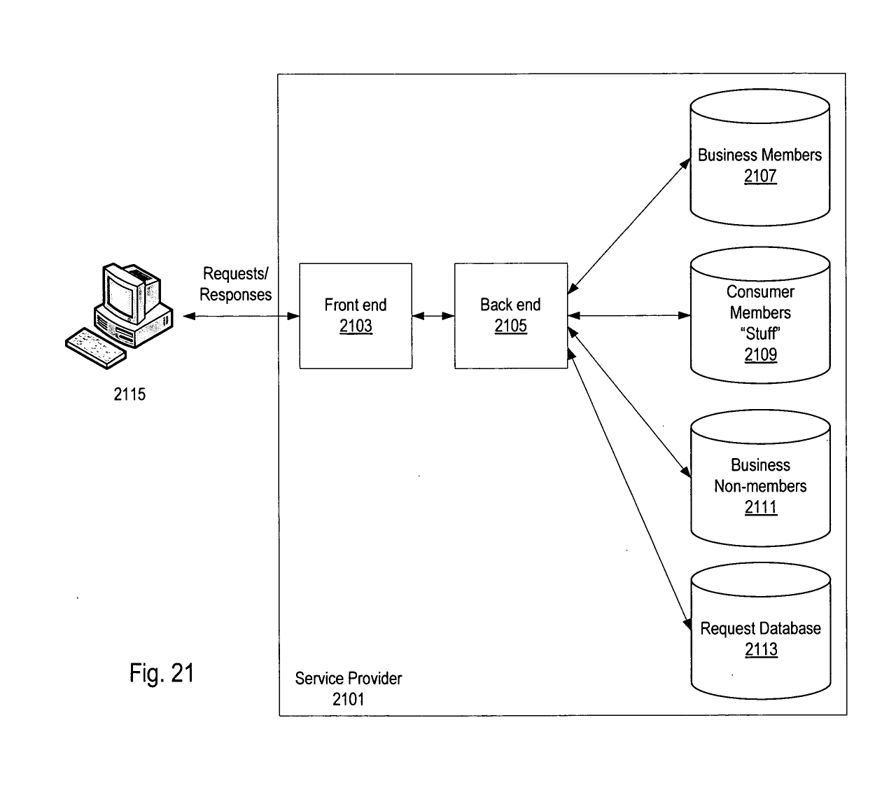

FIG. 20 illustrates an exemplary “anonymous” transaction involving a member of the service provider. The requesting member 2001 sends a request 2007 to the service provider 2003 for the service provider 2003 to try to find a business, professional, or other member to provide a good and/or service. This request may be made from the member's 2001 dashboard or through a page or pages dedicated to these specific types of requests.

The service provider 2003 searches its database(s) for a business, professional, or other member that might be able to fulfill the request and forwards a request 2009 to the business, professional, or other member 2005. The service provider 2003 may also associate the member with an “anonymous” ID. In one embodiment, the request includes an anonymous email address provided by the service provider 2003 to act as the member ID (this email address is based on the “anonymous” ID). In another embodiment, the identifier in the request 2009 is simply used in any response from the business, professional, or other member 2005 for routing purposes (it is not an email address, but could identify either the transaction or be the “anonymous” ID). For example, the “anonymous” ID “11234” of FIG. 19 is associated with the member ID “Butters.” A response from the fulfiller 2005 that includes “11234” would be understood by the service provider 2003 to be associated with “Butters.” Similarly, a response from the fulfiller 2005 that includes transaction number 00000001 would be understood by the service provider 2003 to be about a request for Adidas apparel by “Butters.” Businesses, professionals, or other members 2005 may be contacted through their dashboard, via fax, telephone, email, text message, instant message, etc. with requests 2009. If the requesting member does not care if his/her contact information is shared, the request 2009 includes this information.

After determining if the request can be fulfilled, the business, professional, or other member 2005 transmits a response 2011 to the request. Responses typically include an indication of if the good and/or service is available, the associated cost, etc. If the request 2009 included an email address provided by the service provider 2003, then the business, professional, or other member 2009 should respond to that address (the service provider 2003 will associate this incoming email to the member 2001 and forward it). If the request 2009 just includes an identifier, then the business, professional, or other member 2005 will respond to the service provider 2003 who will forward it to the requesting member 2001. In an embodiment, the business, professional, or other member 2005 receives and/or responds to requests through its dashboard. If the business or professional 2005 is not a member, then direct contact with the business or professional 2005 is made by the service provider 2003.

Upon receiving a response 2011 from the business, professional, or other member 2005, the service provider 2003 associates the response to the appropriate member 2001 and forwards this response 2013 to the requesting member 2001. This forwarding may be accomplished in several different ways. In an embodiment, the response 2013 is placed in the requesting member's 2001 dashboard for him/her to access at any time. In another embodiment, the service provider 2003 forwards the response 2013 to another email account associated with the requesting member 2001. Other ways of contacting the requesting member 2001 include phone contact, text message, instant message, etc.

A non-member may also use this service to make a request. However, the business or professional will need to receive specific contact information allowing direct contact 2015 between the requester and business or professional 2005. Similarly, in an embodiment, a non-member business or professional that has a listing (and thus the service provider 2003 has some information about them) may also use the service.

FIG. 21 illustrates an embodiment of a service provider architecture. The service provider 2101 includes a front end 2103 to interact with a user via the Internet or other network. The front end 2103 provides the Web pages that have been described earlier including member dashboards, search pages, sign-up pages, etc. to the user. It is through this front end 2103 that the user makes requests to the service provider, the service provider responds to the user, the service provider interacts with one or more businesses, professionals, or members that may be able to fulfill the request, etc.

The back end 2105 includes the components/modules that process the output from the front end (including determining which business, professional, or member may be able to fulfill the request; creating one or more anonymous requests to transmit to one or more businesses, professionals, or members; associating any responses to the request to the user that made the request; providing those response to the front end; etc.), feed the front end with responses to requests, and other components/modules for providing the earlier described functionality. As illustrated, the back end 2105 communicates with one or more databases 2107-2113 containing member and non-member information. The business members database 2107 includes information about members of the service provider 2101 that are businesses. This information includes the information contained in the businesses' listings and may also contain more specific information including specific products that the business carries and a substantially up-to-date inventory for the business. This information may be provided by a Web service such as those provided by Microsoft, SAP, and IBM.

The consumer members “stuff” database 2109 includes information about members that are consumers. Consumer members may also update their profile to include items and/or services that they are selling.

The non-member business database 2111 includes information about non-member businesses that have a listing with the service provider. In an embodiment, non-business members cannot update this information.

The request database 2113 stores requests made by members for a particular good and/or service. The database 2113 may also store an indication of the status of the request, the businesses and/or consumer members that may possibly fulfill the request, an identifier to associate with either the request and/or requesting member, etc. While not illustrated, other databases may be utilized and/or the illustrated databases may be combined. Additionally, other non-database storage solutions may be used if similar functionality is available. The service provider 2101 may also employ typical Internet service provider techniques including the use of edge servers with or without local databases for serving the user better.

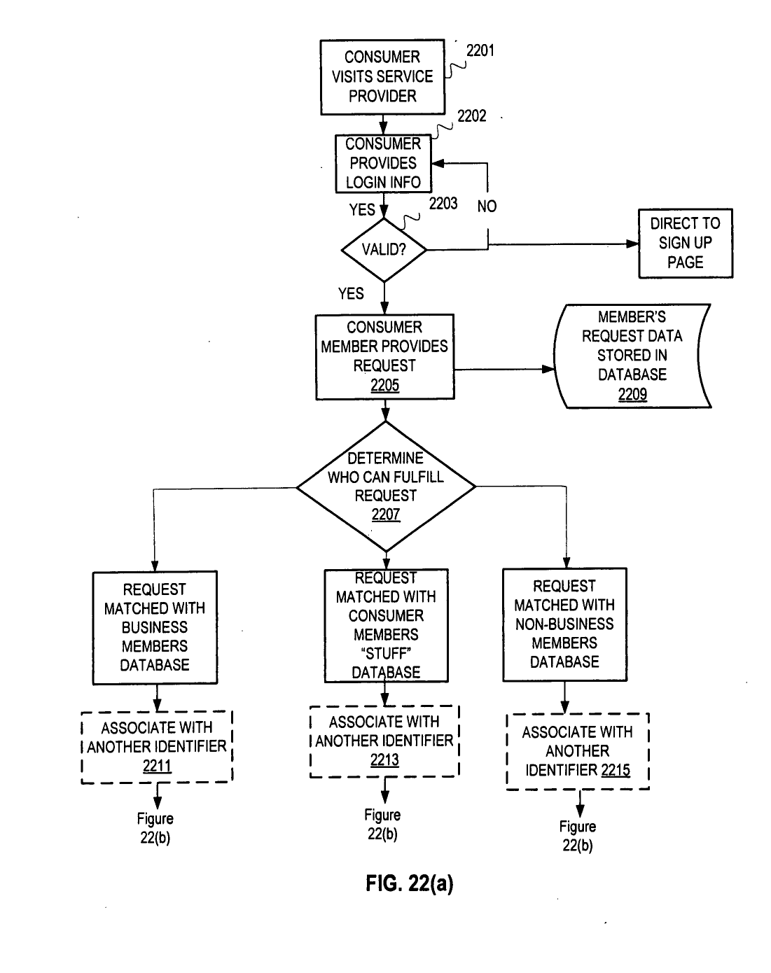

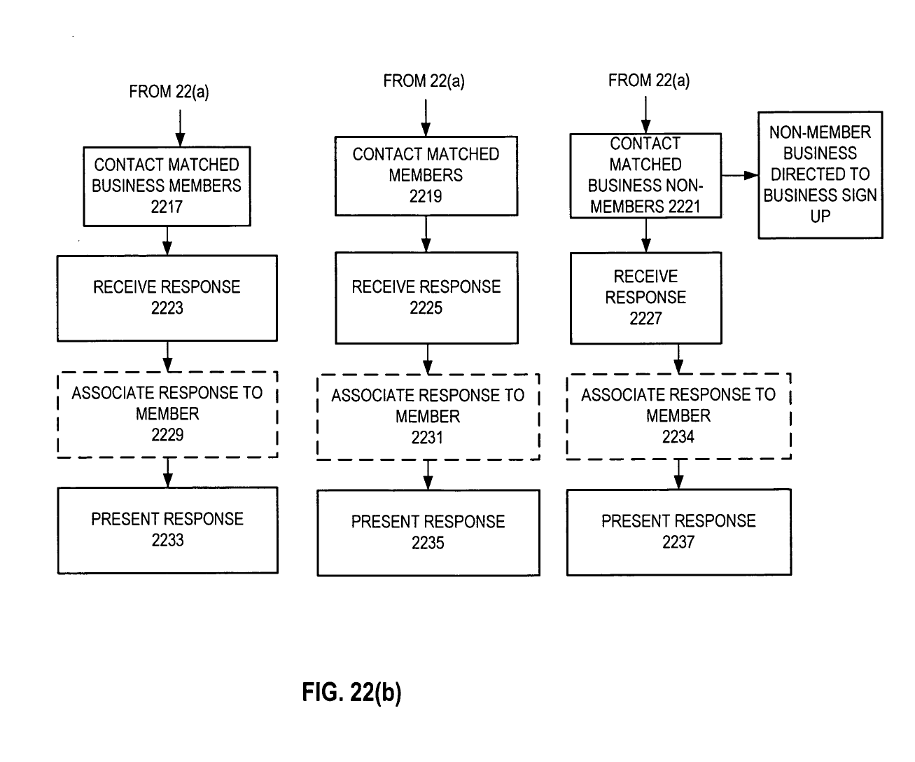

FIGS. 22(a) and (b) illustrate an embodiment of a method for enabling the fulfillment of a goods and/or services request. A consumer visits the website of the service provider at 2201. If the consumer is a member of the service provider, the consumer attempts to log into his account using his/her username and password at 2202. A determination of the validity of the provided credentials is made at 2203. If the username and password are not valid, the member will be prompted to resubmit his/her username and password and/or directed to sign up with the service provider. If the credentials are valid, then the member is typically taken to his/her personalized dashboard such as the dashboard illustrated in FIG. 6 to generate a request. However, a request may be made from other links in the website.

The member provides his/her request to the service provider at 2205. For example, a member “Butters” may request Adidas apparel in Silicon Valley by submitting a request from his dashboard or some other page provided by the service provider. The member's request is stored in a database by the service provider at 2209.

The service provider determines who might be able to fulfill the request at 2207. The service provider makes this determination by comparing the request's contents to various goods and/or services provided by members of the service or non-members that have listings. What goods and/or services provided by members or non-members are stored in one or more databases. For example, with respect to FIG. 21, business members' information is stored in a business members' database 2107, consumer members in a consumer members' database 2109, and non-member businesses in a non-member businesses database 2111. Of course, one or more of these databases may be combined or expanded to multiple databases. In an embodiment, preference is given to members over non-members if more than one of the comparisons turns up a positive result.

If a business or professional member might be able to fulfill the request, the business or professional member is contacted by the service provider with the request or a modified version thereof at 2217. More than one may be contacted and provided a request. As described with respect to FIGS. 19 and 20, the specific ID of the requesting member is normally not known by the receiving party. If the requesting member is to be anonymous, the service provider must first associate the member with an “anonymous” ID or use the transaction identifier before contacting the business member at 2211.

The business or professional member responds to the request through the service provider at 2223 as described with reference to FIG. 20. The service provider presents the response to the requesting member at 2233. If the request was sent “anonymously” to the potential fulfiller, the service provider must first determine which member made the request at 2229. This determination is made by looking at either the transaction or “anonymous” ID and relating this to the proper member. The presentation may be made on the member's dashboard or via one of several other communication methods such as a phone call, direct email, text message, instant message, etc.

If a consumer member might be able to fulfill the request, he/she is contacted by the service provider with the request or a modified version thereof at 2219. More than one consumer member may be contacted and provided a request. As described with respect to FIGS. 19 and 20, the specific ID of the requesting member is normally not known by the receiving consumer member. If the requesting member is to be anonymous, the service provider must first associate the member with an “anonymous” ID or use the transaction identifier before contacting the business member at 2213.

The consumer member responds to the request through the service provider at 2225 as described with reference to FIG. 20. The service provider presents the response to the requesting member at 2235. If the request was sent “anonymously” to the potential fulfiller, the service provider must first determine which member made the request at 2231. This determination is made by looking at either the transaction or “anonymous” ID and relating this to the proper member. This presentation may be made on the member's dashboard or via one of several other communication methods such as a phone call, direct email, text message, instant message, etc.

If a non-member business or professional might be able to fulfill the request, the non-member business or professional is contacted by the service provider with the request or a modified version thereof at 2221. More than one non-member business may be contacted and provided a request. As described with respect to FIGS. 19 and 20, the specific ID of the requesting member is normally not known by the receiver. If the requesting member is to be anonymous, the service provider must first associate the member with an “anonymous” ID or use the transaction identifier prior to contacting the business member at 2215.

The non-member responds to the request through the service provider at 2227 as described with reference to FIG. 20. The service provider presents the response to the requesting member at 2237. If the request was sent “anonymously” to the potential fulfiller, the service provider must first determine which member made the request at 2234. This determination is made by looking at either the transaction or “anonymous” ID and relating this to the proper member. This presentation may be made on the member's dashboard or via one of several other communication methods such as a phone call, direct email, text message, instant message, etc.

In an embodiment, the non-member business is directed to sign up with the service prior to being provided with contact information for the requester. In another embodiment, the non-business member responds to the request in the same manner as a regular member.

Once the requesting member has received one or more responses to his/her request, he/she may sort through those requests to determine which one he/she prefers.

The above described method may also be applied to non-members. However, non-members would have to provide contact information so that the business, professional, or member could respond to the request.

### Closing Comments

An article of manufacture may be used to store program code providing at least some of the functionality of the service provider described above. An article of manufacture that stores program code may be embodied as, but is not limited to, one or more memories (e.g., one or more flash memories, random access memories (static, dynamic or other)), optical disks, CD-ROMs, DVD-ROMs, EPROMs, EEPROMs, magnetic or optical cards or other type of machine-readable media suitable for storing electronic instructions.

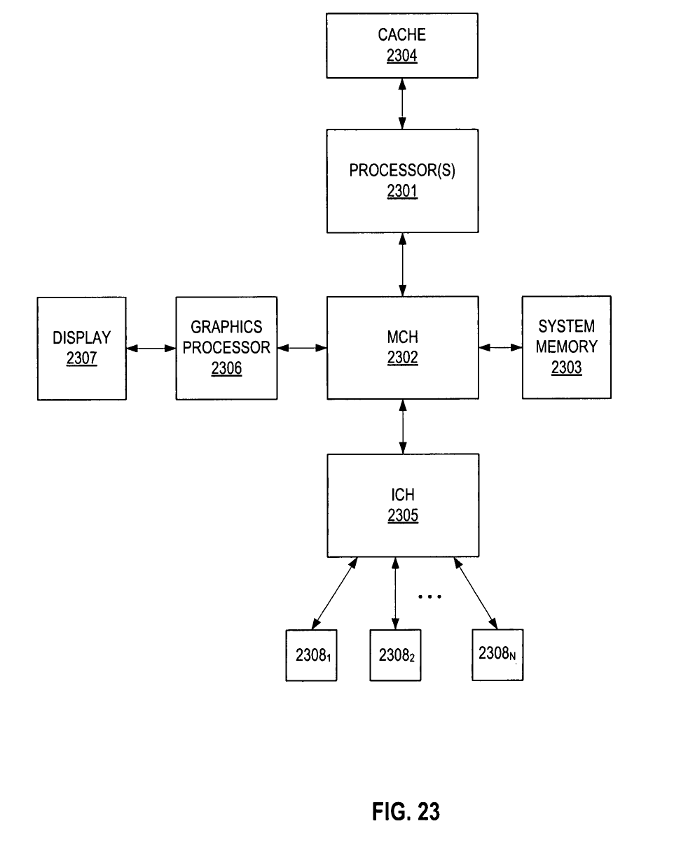

FIG. 23 shows an embodiment of a computing system (e.g., a computer) such as what would constitute a service provider. The exemplary computing system of FIG. 23 includes: 1) one or more processors 2301; 2) a memory control hub (MCH) 2302; 3) a system memory 2303 (of which different types exist such as DDR RAM, EDO RAM, etc,); 4) a cache 2304; 5) an I/O control hub (ICH) 2305; 6) a graphics processor 2306; 7) a display/screen 2307 (of which different types exist such as Cathode Ray Tube (CRT), Thin Film Transistor (TFT), Liquid Crystal Display (LCD), Digital Light Processing (DLP), Organic LED (OLED), etc.; and 8) one or more I/O and storage devices 2308.

The one or more processors 2301 execute instructions in order to perform whatever software routines the computing system implements. The instructions frequently involve some sort of operation performed upon data. Both data and instructions are stored in system memory 2303 and cache 2304. Cache 2304 is typically designed to have shorter latency times than system memory 2303. For example, cache 2304 might be integrated onto the same silicon chip(s) as the processor(s) and/or constructed with faster SRAM cells whilst system memory 2303 might be constructed with slower DRAM cells. By tending to store more frequently used instructions and data in the cache 2304 as opposed to the system memory 2303, the overall performance efficiency of the computing system improves.

System memory 2303 is deliberately made available to other components within the computing system. For example, the data received from various interfaces to the computing system (e.g., keyboard and mouse, printer port, LAN port, modem port, etc.) or retrieved from an internal storage element of the computing system (e.g., hard disk drive) are often temporarily queued into system memory 2303 prior to their being operated upon by the one or more processor(s) 2301 in the implementation of a software program. Similarly, data that a software program determines should be sent from the computing system to an outside entity through one of the computing system interfaces, or stored into an internal storage element, is often temporarily queued in system memory 2303 prior to its being transmitted or stored. The system memory 2303 may includes one or more modules to provide the functionality described above including, but not limited to, modules for: generating a Web site including a search page, member dashboards (and the functionality described with respect to the dashboard including referring friends, generating/editing listings, viewing compensation earned, etc.), listings, etc.; determining compensation for the members of the service provider; handling payments to or from the service provider and members; storing listings; etc. These modules may also be stored on articles of manufacture and executed at runtime by the computing system.

The ICH 2305 is responsible for ensuring that such data is properly passed between the system memory 2303 and its appropriate corresponding computing system interface (and internal storage device if the computing system is so designed). The MCH 2302 is responsible for managing the various contending requests for system memory 2303 access amongst the processor(s) 2301, interfaces and internal storage elements that may proximately arise in time with respect to one another.

One or more I/O devices 2308 are also implemented in a typical computing system. I/O devices generally are responsible for transferring data to and/or from the computing system (e.g., a networking adapter); or, for large scale non-volatile storage within the computing system (e.g., hard disk drive). ICH 2305 has bi-directional point-to-point links between itself and the observed I/O devices 2308.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense. For example, the service provider may not host listings using its computers but rather contract the hosting to a third-party hosting provider. Additionally, while the description above details an Internet based search engine, the listings may be distributed on physical media such as a CD-ROM or DVD-ROM.

The above described approach to business advertising provides a benefit to members of the service provider (consumers and businesses) and non-members of the service provider who can simply search for the information that they need. Consumers, looking for a local product or service, benefit because they have immediate access to current and comparative information. Businesses and professionals benefit because the service provider supplies an easy and inexpensive way to provide the general public with current information on their products, services, and sales and/or specials. Consumers who are also members have the opportunity to benefit financially as they participate in providing information to the service provider's expanding database of listings. The described member request and response scheme may be applied to Internet transactions as well as conventional systems such as, person to person, voice telephony, cell phone technology, television, etc.

We claim:

1. A method comprising:
receiving a request from a requester at a service provider for a good or service provided by an entity known to the service provider;
determining if an entity might be able to fulfill the received request by comparing the request to information stored in a database regarding the goods or services associated with entities known to the service provider; and
contacting the entity with information from the request and substantially anonymous contact information for the person making the request, if the entity might be able to fulfill the request.

2. The method of claim 1, wherein the request includes a time limit for a response from the entity.

3. The method of claim 1, further comprising:
determining if the entity that has a listing hosted by the service provider but that is not a member of the service provider but might be able to fulfill the received request by comparing the request to information stored in the database regarding the goods or services associated with the entity;
contacting the entity with information from the request and information on how to join the service provider; and
providing the business with the requester's contact information if the entity joins the service provider.

4. The method of claim 1, wherein the requester's information is associated with the request and will only be used by the entity in a response to the request.

5. The method of claim 1, further comprising:
presenting a Web page with a request form including any search categories provided by the service provider.

6. The method of claim 1, wherein the request includes a keyword associated with the entity.

7. The method of claim 1, further comprising:
reviewing the request to determine if the request is consistent with the service provider's terms of use.

8. The method of claim 1, wherein more than one database is searched for an entity that might be able to fulfill the request.

9. The method of claim 1, further comprising:
receiving a response from the entity regarding the request;
associating the response to the requester; and
providing the response to the requester.

10. A method comprising:
receiving a request from a first member of a service provider for a good or service;
determining if a second member can fulfill the received request by comparing the request to information stored in a database regarding the goods or services associated with a second member of the service provider; and
contacting the second member with information from the request and contact information for the first member if the second member can fulfill the request.

11. The method of claim 10, wherein the request includes a time limit for a response from the second member.

12. The method of claim 10, further comprising:
determining if a business that has a listing hosted by the service provider but that is not a member of the service provider can fulfill the received request by comparing the request to information stored in the database regarding the goods or services associated with the business; contacting the business with information from the request and information on how to join the service provider; and
providing the business with the first member's contact information if the business joins the service provider.

13. The method of claim 10, wherein the first member's contact information is associated with the request and once used by the second member in a response to the first member will no longer be associated with the first member.

14. The method of claim 10, further comprising:
presenting the first member with a request form including any search categories provided by the service provider.

15. The method of claim 10, wherein the request includes a keyword associated with the second member.

16. The method of claim 10, further comprising:
reviewing the request to determine if the request is consistent with the service provider's terms of use.

17. The method of claim 10, further comprising:
receiving a response from the second member regarding the request;
associating the response with the first member; and
providing the response to the first member.

18. A system comprising:
a service provider including,
a front end to
receive a request for a good and/or service from a user to an entity known to the service provider that might be able to fulfill the request,
provide a modified version of the request to the entity,
receive a response from the entity, and
provide a response to that request to the user, and
a back end to
determine which entity might be able to fulfill the request,
associate the request with the user making the request, and
process the response from the entity; and
a network to facilitate communication between the service provider and the plurality of users.

19. The system of claim 18, wherein the entity is a member of the service provider.

20. The system of claim 18, wherein the modified request is substantially anonymous with respect to the identification of the user that made the request,

21. A method comprising:
receiving a request from a first member of a service provider for a good or service provided by a second member of the service provider;
determining if the second member might be able to fulfill the received request by comparing the request to information stored in a database regarding the goods or services provided the second member;
generating a substantially anonymous identifier for the first member and associating it with the received request;
revising the request to remove information that specifically identifies the first member and replacing that information with the substantially anonymous identifier;
contacting the second member with the revised request;
receiving a response to the revised request from the second member, wherein the response includes the substantially anonymous identifier;
associating the received response with the first member based on the received substantially anonymous identifier; and
presenting the received response to the first member.

22. The method of claim 21, wherein the database includes a substantially up-to-date inventory for the goods provided by the second member.
